(19) United States
(12) Patent Application Publication
(10) Pub. No.: US 2008/0307708 A1
(43) Pub. Date: Dec. 18, 2008

(54) Folding security gate

(76) Inventor: Paul H. Quan, San Francisco, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/073,989

(22) Filed: Mar. 12, 2008

Related U.S. Application Data
(60) Provisional application No. 60/929,120, filed on Jun. 13, 2007.

(51) Int. Cl. E06B 9/01

(52) U.S. Cl. 49/55

(57) ABSTRACT

The folding security gate folds up vertically against a door frame when not in use. The gate is fabricated from four U-shaped channels hinged together to form a rectangular frame. Strands of netting material are stretched across the opening of the frame and are attached to the frame. One side of the frame is disposed against the door frame and secured thereto either permanently or temporarily as desired. The remaining segments of the frame are hinged together in a manner to allow rotation.

### CROSS-REFERENCE TO RELATED APPLICATION

This application claims the benefit of U.S. Provisional Patent Application Ser. No. 60/929,120, filed Jun. 13, 2007.

### BACKGROUND OF THE INVENTION

1. Field of the Invention

The present invention generally relates to barriers. More specifically, the present invention is drawn to a folding security gate that can be folded compactly against a door frame when not in use.

2. Description of the Related Art

Although the home is considered to be a place where the safety of the inhabitants is paramount, accidents occur in the family environment with alarming frequency. In fact, accidents to small children are more likely to occur in the home than in any other venue. A toddler wandering from a “safe” room into another room that is not “childproof” or wandering out of the house and into the yard or street are common events that presage accidents. Another scenario involves a small child falling down a stairway when he/she leaves a room through an unsecured doorway. And let's not forget the pet poodle straying to a forbidden area of the home or out of the yard. Unfortunately, it is not always feasible to provide a closed door to block an open doorway or passageway to secure safe areas.

Heretofore, telescoping gates have been utilized as a means to provide secure barriers for the doorways of safe areas. However, the telescoping gates currently used have proven less than satisfactory in that they are cumbersome, easily dislodged from the doorway and present an unsightly appearance when telescoped in a non-use position. The art would certainly welcome a sturdy barrier for a doorway than can be quickly and easily folded to a non-use position that presents minimum interference to the use of the entire doorway.

Thus a folding security gate solving the aforementioned problems is desired.

### SUMMARY OF THE INVENTION

The folding security gate is a security gate that folds vertically against a door frame when not in use. The gate is fabricated from four U-shaped channels, which are hinged together to form a rectangular frame. Strands of netting material are stretched across the opening of the frame and are attached to the frame. One side of the frame is disposed against the door frame and secured thereto, either permanently or temporarily, as desired. The remaining segments of the frame are hinged together in a manner to allow rotation. This arrangement permits the frame to be disposed in either an in-use position as a barrier spanning the opening of the doorway, or in a vertical position wherein the frame is stowed against the door frame.

Accordingly, the folding security gate is a security gate that is sturdy, easy to install and convenient to use. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a folding security gate according to the present invention.

FIG. 2 is a front view of a folding security gate according to the present invention in a partially folded position.

FIG. 3 is a front view of a folding security gate according to the present invention in a fully folded position.

FIG. 4 is an exploded, perspective view of a first embodiment of folding security gate according to the present invention in a partially folded position.

FIG. 5 is a partial, exploded, perspective view of a first embodiment of folding security gate according to the present invention in a partially folded position.

FIG. 6 is an exploded, perspective view of a second embodiment of folding security gate according to the present invention in a partially folded position.

Similar reference characters denote corresponding features consistently throughout the attached drawings.

### DETAILED DESCRIPTION OF THE PREFERRED EMBODIMENTS

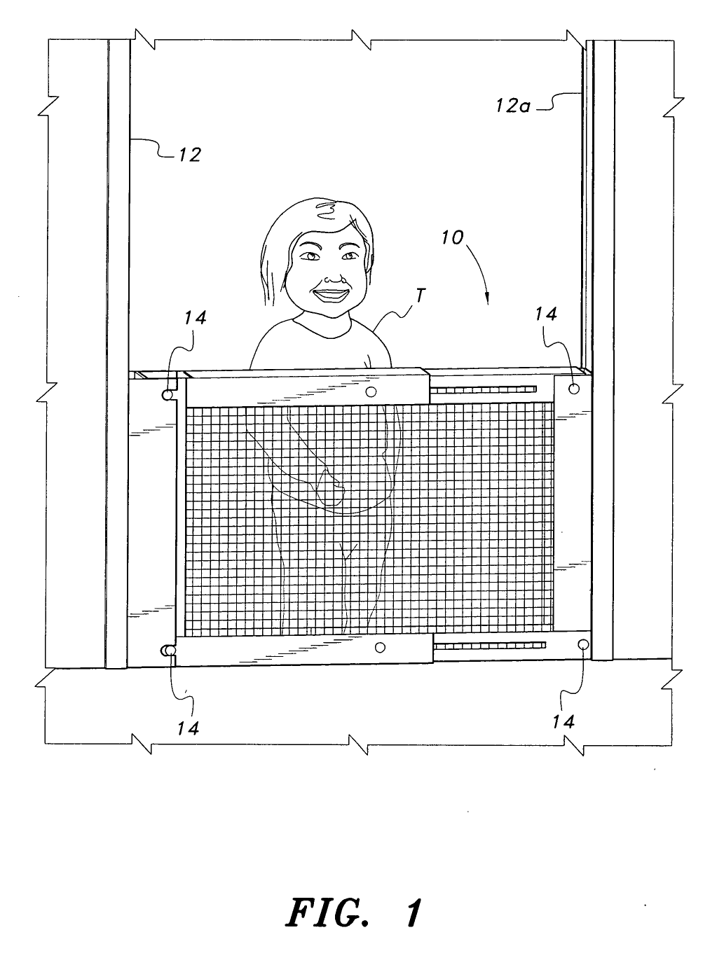

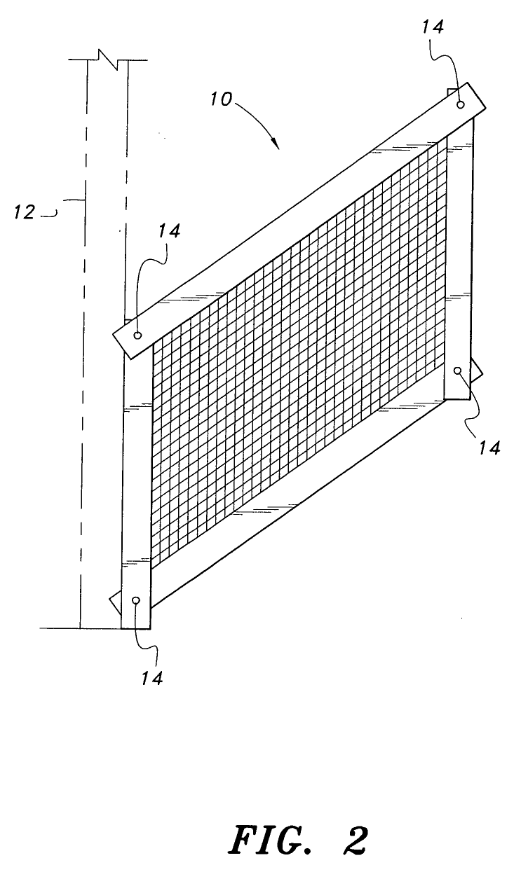

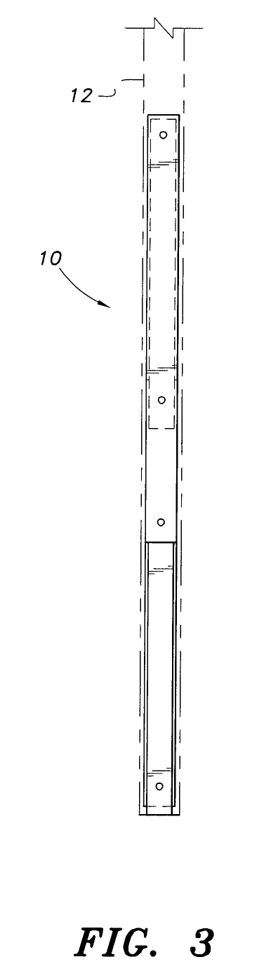

Attention is first directed to FIGS. 1-3, wherein a folding security gate of the present invention is generally indicated at 10. FIG. 1 shows gate 10 in an in-use position spanning the opening in a doorway. Gate 10 can be attached to one side 12 of the doorway frame in any conventional or convenient manner. The attachment can be permanent or temporary. Gate 10 is secured to the other side 12a of the doorway frame in a manner to be easily latched or unlatched by an adult or older child-but not by a toddler T. Gate 10 is provided with pivot pins 14 at each corner thereof to permit the gate 10 to be rotated in a manner to store the gate 10 against side 12 of the doorway frame when the gate 10 is not in use. FIG. 2 shows the gate 10 in a quasi-stored position as it is rotated upwardly. FIG. 3 shows the gate 10 fully rotated to a stored position against side 12 of the doorway.

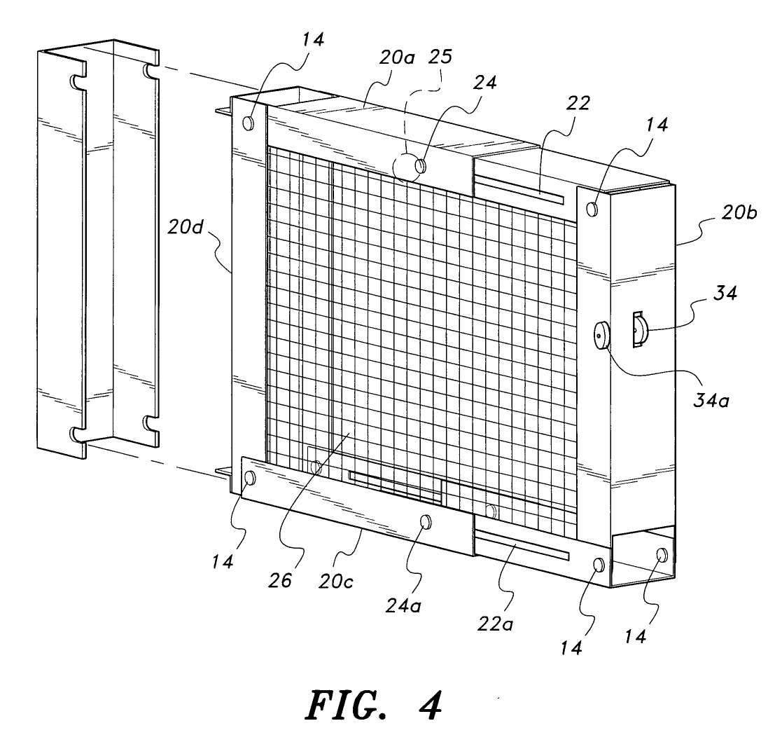

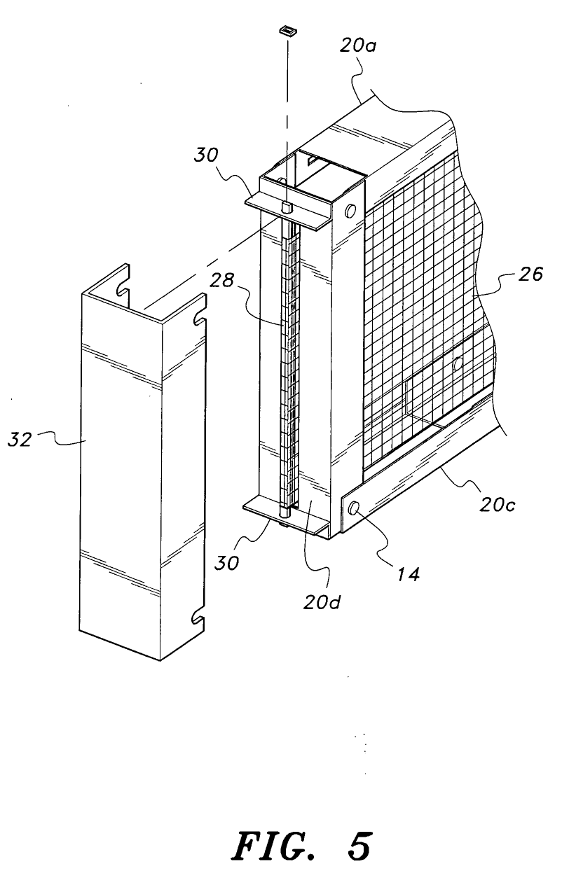

Attention is now directed to FIGS. 4 and 5, which show a first embodiment of the invention. Gate 10 comprises four U-shaped channels 20a, 20b, 20c and 20d. The U-shaped channels 20a-20d are configured to form a rectangle defining an opening. Although plastic is preferred, the channels 20a-20d can be fabricated from any suitable material. As stated above, pivot pins 14 are disposed at each corner of the gate 10 in order to allow the gate 10 to be rotated. Top and bottom channels 20a and 20c are fabricated as two telescopically arranged channels. Respective slots 22, 22a are disposed in channels 20a, 20c and receive respective slide pins 24, 24a therein. This arrangement allows the width of the gate 10 to be adjusted to fit doorway openings of different widths. A tightening knob 25 (shown in phantom lines) is provided to tighten the assembly once the desired width has been obtained. The opening defined by the frame of the gate 10 is spanned with a mesh netting material 26. Netting material 26 is fabricated from a single piece of strong, durable fiber. The netting 26 is attached along one end to an inner surface of vertical channel 20b. At its other end, netting 26 is attached to a rod 28. Rod 28 is mounted for rotation in brackets 30. Brackets 30 are mounted on an outer face of channel 20d. Rotation of rod 28 adjusts the width of netting 26, thereby ensuring that the netting 26 is always taut. Member 32 is disposed for attachment to channel 20d and to rod 28. Member 32 will be attached to frame side 12 in any conventional and appropriate manner. An eccentric cam 34 and knob 34a mechanism is used to tighten the assembly against side 12a of the doorway frame.

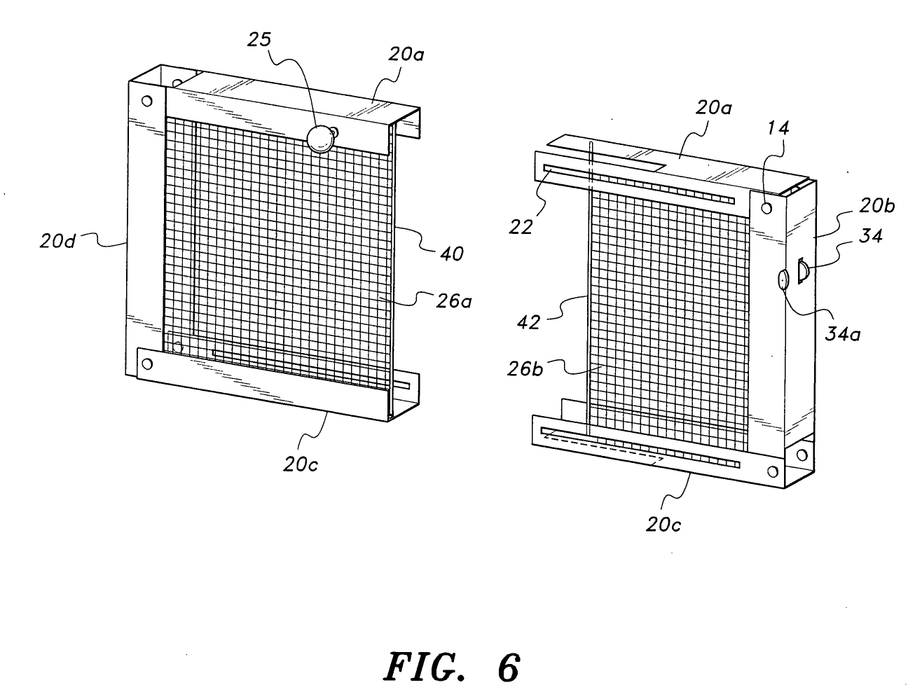

In a second embodiment, shown in FIG. 6, rod 28 is eliminated and the netting is fabricated in separate pieces 26a and 26b. Three of the four edges of netting 26a are respectively attached to channels 20a, 20c and 20d. The fourth edge is attached to a vertical rod 40. Rod 40 is attached at its upper end to channel 20a and at its lower end to channel 20c by means of brackets or the like (not shown). Rod 40 is positioned adjacent proximate inner surfaces of channels 20a and 20c. Three of the four edges of netting 26b are respectively attached to channels 20a, 20b and 20c. The fourth edge is attached to a vertical rod 42. Rod 42 is attached at its upper end to channel 20a and at its lower end to channel 20c by means of brackets or the like (not shown). Rod 42 is positioned adjacent distal inner surfaces of channels 20a and 20c. This arrangement permits the netting 26a and 26b to overlap when the gate is adjusted thereby always presenting a taut barrier. The gate of FIG. 6 will be rotated and stored against the doorway in the same manner as the gate of FIGS. 4 and 5.

It is to be understood that the present invention is not limited to the embodiments described above, but encompasses any and all embodiments within the scope of the following claims.

I claim:

1. A folding security gate, comprising:
a rectangular frame having four corners, the frame defining a central opening;
a mesh netting material attached to the rectangular frame, the netting spanning the central opening; and
pivot pins disposed in each of the four corners of the frame, whereby the rectangular frame is attachable to a planar surface and can be rotated thereagainst to fold the frame and collapse the netting.

2. The folding security gate according to claim 1, wherein said rectangular frame is fabricated from four U-shaped channels.

3. The folding security gate according to claim 1, wherein said mesh netting material is fabricated as a single piece.

4. The folding security gate according to claim 1, wherein said mesh netting material comprises two overlapping pieces of mesh netting material.

5. The folding security gate according to claim 1, wherein said frame is fabricated from plastic material.

6. The folding security gate according to claim 1, wherein said frame is fabricated from metallic material.

7. The folding security gate according to claim 1, wherein said frame is telescopically adjustable in a horizontal direction.

8. A folding security gate, comprising:
first and second vertically oriented, U-shaped channel members, the first and second vertically oriented channel members being spaced apart from each other;
a first horizontally oriented, U-shaped channel member pivotally attached to the first and second vertically oriented U-shaped channel members;
a second horizontally oriented, U-shaped channel member pivotally attached to the first and second vertically oriented, U-shaped channel members; the first and second vertically-oriented, U-shaped channel members and the first and second U-shaped, horizontally oriented channel members forming a rectangular frame defining a central opening; and
a horizontally adjustable mesh netting material attached to the rectangular frame, the netting spanning the central opening.

9. The folding security gate according to claim 8, wherein said mesh netting material is fabricated as a single piece.

10. The folding security gate according to claim 8, wherein said mesh netting material comprises two at least partially overlapping pieces of netting material.

11. The folding security gate according to claim 8, wherein said first and second vertically-oriented, U-shaped channel members and said first and second U-shaped, horizontally-oriented channel members are fabricated from plastic material.

12. The folding security gate according to claim 8, wherein said first and second vertically-oriented, U-shaped channel members and said first and second U-shaped, horizontally-oriented channel members are fabricated from metallic material.

13. The folding security gate according to claim 8, wherein said first and second U-shaped, horizontally-oriented channel members are telescopically adjustable in a horizontal direction.

14. The folding security gate according to claim 8, further comprising a rod member rotatably attached to the first vertically-oriented, U-shaped member, said horizontally adjustable mesh netting material having a first end attached to the rod member and a second end attached to said second vertically-oriented, U-shaped member.

15. The folding security gate according to claim 8, further including a cam and knob mechanism disposed on said second vertically-oriented, U-shaped member, whereby the gate can be tightened against a planar surface.
